(19) United States
(12) Patent Application Publication
(10) Pub. No.: US 2006/0045170 A1
(43) Pub. Date: Mar. 2, 2006

(54) Apparatus and method for canceling interference in a single antenna 1xEV-DV mobile station

(75) Inventors: Cornelius van Rensburg, Dallas, TX (US); Lai King Tee, Dallas, TX (US); Joseph R. Cleveland, Murphy, TX (US)

Correspondence Address: DOCKET CLERK, P.O. DRAWER 800889, DALLAS, TX, 75380, US

(73) Assignee: SAMSUNG ELECTRONICS CO., LTD., Suwon-city (KR)

(21) Appl. No.: 10/929,842

(22) Filed: Aug. 30, 2004

(51) Int. Cl. H04B 1/707

(52) U.S. Cl. 375/148; 375/149

(57) ABSTRACT

A mobile station for canceling interference caused by a dominant interferer signal in a 1xEV-DV wireless network. The mobile station comprises an RF down-converter for outputting a down-converted signal, r(n); a first PN demodulator for multiplying the down-converted r(n) signal by a first PN code sequence to produce a first demodulated output signal; W Walsh code demodulators that multiply the first demodulated output signal by a selected set of W Walsh codes to produce W raw user signals; W subtractors that subtract a selected estimated interference signal from one of the W raw user signals to produce W estimated user signals; and a detector that outputs a detected user signal for each of the W estimated user signals that exceeds a first threshold value. The mobile station further comprises an interference estimator that receives W detected user signals from the first detector and outputs W estimated interference signals to the W subtractors.

### TECHNICAL FIELD OF THE INVENTION

The present invention is directed generally to 1xEV-DV wireless networks and, more specifically, to an apparatus for canceling interference in a 1xEV-DV mobile station that uses a single antenna.

### BACKGROUND OF THE INVENTION

Wireless communications systems, including cellular phones, paging devices, personal communication services (PCS) systems, and wireless data networks, have become ubiquitous in society. To attract new customers, wireless service providers continually seek to improve wireless services cheaper and better, such as by implementing new technologies that reduce infrastructure costs and operating costs, increase handset battery lifetime, and improve quality of service (e.g., signal reception).

CDMA technology is used in wireless computer networks, paging (or wireless messaging) systems, and cellular telephony. In a CDMA system, mobile stations (e.g., pagers, cell phones, laptop PCs with wireless modems) and base stations transmit and receive data in assigned channels that correspond to specific unique codes. For example, a mobile station may receive forward channel data signals from a base station that are convolutionally coded, formatted, interleaved, spread with a Walsh code and a long pseudo-noise (PN) sequence. In another example, a base station may receive reverse channel data signals from the mobile station that are convolutionally encoded, block interleaved, and spread prior to transmission by the mobile station. The data symbols following interleaving may be separated into an in-phase (I) data stream and a quadrature (Q) data stream for QPSK modulation of an RF carrier. One such implementation is found in the 1xEV-DV version of the IS-2000 standard.

In a 1xEV-DV wireless network, two types of interference limit the performance of the forward link (i.e., transmission link from base station to mobile station). When the mobile station is close to the base station, same cell interference due to multi-path reflections is the predominant type of interference. When the mobile station is at the outer edge of the cell site, neighboring cell interference is the predominant type of interference. Same cell interference is directly related to the transmit power of the base station. Since both 1xEV-DO and 1xEV-DV base stations continuously transmit at maximum power for packet data users, same cell interference is extreme in 1xEV-DO and 1xEV-DV wireless networks.

Unfortunately, due to a number of constraints, conventional CDMA, 1xEV-DO and 1xEV-DV mobile stations do not implement any of the known interference cancellation techniques. Known interference cancellation techniques are applied during user signal detection in the base stations of multi-access CDMA systems. These techniques are sometimes referred to as multi-user detection (MUD) schemes. Since the prior art does not use interference cancellation, 1xEV-DV cells typically maintain a maximum of only three or four voice calls while maintaining data sessions.

Therefore, there is a need in the art for an improved mobile station that is capable of canceling same cell interference within a cell site. In particular, there is a need for a single antenna mobile station that is capable of canceling interference when the mobile station is in an area close to the base station where multipath interference predominates.

### SUMMARY OF THE INVENTION

The present invention introduces an apparatus and a related method for canceling interference in a mobile station, thereby enabling the mobile station to receive very low power signals. This results in increased capacity in each base station and in the wireless network. The cancellation algorithm of the present invention exploits the fact that it is known a priori that the Packet Data Channel is the strongest interferer in a 1xEV-DV system. It is therefore easier to cancel it. Existing interference cancellation schemes are required to first determine the strongest interferer signal, thereby reducing performance.

To address the above-discussed deficiencies of the prior art, it is a primary object of the present invention to provide a mobile station capable of canceling interference caused by a dominant interferer signal for use in a 1xEV-DV wireless network. According to an advantageous embodiment of the present invention, the mobile station comprises: 1) a radio frequency (RF) down-converter for receiving an RF signal and outputting a down-converted signal, r(n); 2) a first pseudo-random noise (PN) demodulator capable of multiplying the down-converted r(n) signal by a first PN code sequence to produce a first demodulated output signal; 3) a first group of W Walsh code demodulators, each of the W Walsh code demodulators capable of multiplying the first demodulated output signal by a selected Walsh code used in the 1xEV-DV wireless network to produce a raw user signal, the first group of W Walsh code demodulators producing W raw user signals; 4) a first group of W subtractors, each of the W subtractors capable of subtracting a selected estimated interference signal from a corresponding one of the W raw user signals to produce an estimated user signal, the first group of W subtractors thereby producing W estimated user signals; and 5) a first detector capable of receiving the W estimated user signals and determining which of the W estimated user signals exceeds a first threshold value.

According to one embodiment of the present invention, the first detector outputs a detected user signal for each of the W estimated user signals, the first detector thereby producing W detected user signals.

According to another embodiment of the present invention, the first detector outputs a detected user signal equal to zero for each of the W estimated user signals that does not exceed the first threshold value.

According to still another embodiment of the present invention, the mobile station further comprises an interference estimator capable of receiving the W detected user signals from the first detector and comparing an interference signal in each of the W detected user signals to a second threshold value.

According to yet another embodiment of the present invention, the interference estimator outputs an estimated interference signal for each of the W detected user signals, the interference estimator thereby producing a first group of W estimated interference signals.

According to a further embodiment of the present invention, the interference estimator outputs an estimated interference signal equal to zero for each of the W detected user signals in which the interference signal does not exceed the second threshold value.

According to a still further embodiment of the present invention, each of the W estimated interference signals is applied as an input to a corresponding one of the W subtractors.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 illustrates an exemplary wireless network in which 1xEV-DV mobile stations cancel interference according to the principles of the present invention;

FIG. 2 illustrates selected portions of the transmit path in an exemplary base station of the wireless network in FIG. 1 according to an exemplary embodiment of the present invention;

FIG. 3 illustrates selected portions of the receive path of an exemplary mobile station that cancels interference according to the principles of the present invention; and

FIG. 4 illustrates in greater detail selected portions of the interference cancellation circuitry in the exemplary mobile station according to one embodiment of the present invention.

### DETAILED DESCRIPTION OF THE INVENTION

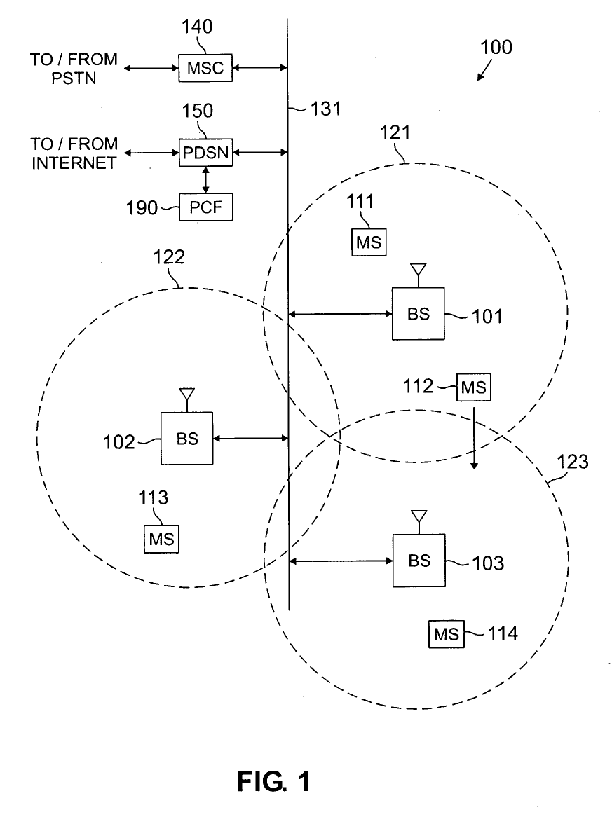

FIGS. 1 through 4, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged mobile station.

FIG. 1 illustrates exemplary wireless network 100, in which 1xEV-DV mobile stations cancel interference according to the principles of the present invention. Wireless network 100 comprises a plurality of cell sites 121-123, each containing one of the base stations, BS 101, BS 102, or BS 103. Base stations 101-103 communicate with a plurality of mobile stations (MS) 111-114 over code division multiple access (CDMA) channels according to, for example, the 1xEV-DV standard. In an advantageous embodiment of the present invention, mobile stations 111-114 are capable of receiving data traffic and/or voice traffic on two or more CDMA channels simultaneously. Mobile stations 111-114 may be any suitable wireless devices (e.g., conventional cell phones, PCS handsets, personal digital assistant (PDA) handsets, portable computers, telemetry devices) that are capable of communicating with base stations 101-103 via wireless links.

The present invention is not limited to mobile devices. The present invention also encompasses other types of wireless access terminals, including fixed wireless terminals. For the sake of simplicity, however, only mobile stations are shown and discussed hereafter. However, it should be understood that the use of the term “mobile station” in the claims and in the description below is intended to encompass both truly mobile devices (e.g., cell phones, wireless laptops) and stationary wireless terminals (e.g., a machine monitor with wireless capability).

Dotted lines show the approximate boundaries of cell sites 121-123 in which base stations 101-103 are located. The cell sites are shown approximately circular for the purposes of illustration and explanation only. It should be clearly understood that the cell sites may have other irregular shapes, depending on the cell configuration selected and natural and man-made obstructions.

As is well known in the art, each of cell sites 121-123 is comprised of a plurality of sectors, where a directional antenna coupled to the base station illuminates each sector. The embodiment of FIG. 1 illustrates the base station in the center of the cell. Alternate embodiments may position the directional antennas in corners of the sectors. The system of the present invention is not limited to any particular cell site configuration.

In one embodiment of the present invention, each of BS 101, BS 102 and BS 103 comprises a base station controller (BSC) and one or more base transceiver subsystem(s) (BTS). Base station controllers and base transceiver subsystems are well known to those skilled in the art. A base station controller is a device that manages wireless communications resources, including the base transceiver subsystems, for specified cells within a wireless communications network. A base transceiver subsystem comprises the RF transceivers, antennas, and other electrical equipment located in each cell site. This equipment may include air conditioning units, heating units, electrical supplies, telephone line interfaces and RF transmitters and RF receivers. For the purpose of simplicity and clarity in explaining the operation of the present invention, the base transceiver subsystems in each of cells 121, 122 and 123 and the base station controller associated with each base transceiver subsystem are collectively represented by BS 101, BS 102 and BS 103, respectively.

BS 101, BS 102 and BS 103 transfer voice and data signals between each other and the public switched telephone network (PSTN) (not shown) via communication line 131 and mobile switching center (MSC) 140. BS 101, BS 102 and BS 103 also transfer data signals, such as packet data, with the Internet (not shown) via communication line 131 and packet data server node (PDSN) 150. Packet control function (PCF) unit 190 controls the flow of data packets between base stations 101-103 and PDSN 150. PCF unit 190 may be implemented as part of PDSN 150, as part of MSC 140, or as a stand-alone device that communicates with PDSN 150, as shown in FIG. 1. Line 131 also provides the connection path for control signals transmitted between MSC 140 and BS 101, BS 102 and BS 103 that establish connections for voice and data circuits between MSC 140 and BS 101, BS 102 and BS 103.

Communication line 131 may be any suitable connection means, including a T1 line, a T3 line, a fiber optic link, a network packet data backbone connection, or any other type of data connection. Line 131 links each vocoder in the BSC with switch elements in MSC 140. The connections on line 131 may transmit analog voice signals or digital voice signals in pulse code modulated (PCM) format, Internet Protocol (IP) format, asynchronous transfer mode (ATM) format, or the like.

MSC 140 is a switching device that provides services and coordination between the subscribers in a wireless network and external networks, such as the PSTN or Internet. MSC 140 is well known to those skilled in the art. In some embodiments of the present invention, communications line 131 may be several different data links where each data link couples one of BS 101, BS 102, or BS 103 to MSC 140.

In the exemplary wireless network 100, MS 111 is located in cell site 121 and is in communication with BS 101. MS 113 is located in cell site 122 and is in communication with BS 102. MS 114 is located in cell site 123 and is in communication with BS 103. MS 112 is also located close to the edge of cell site 123 and is moving in the direction of cell site 123, as indicated by the direction arrow proximate MS 112. At some point, as MS 112 moves into cell site 123 and out of cell site 121, a hand-off will occur.

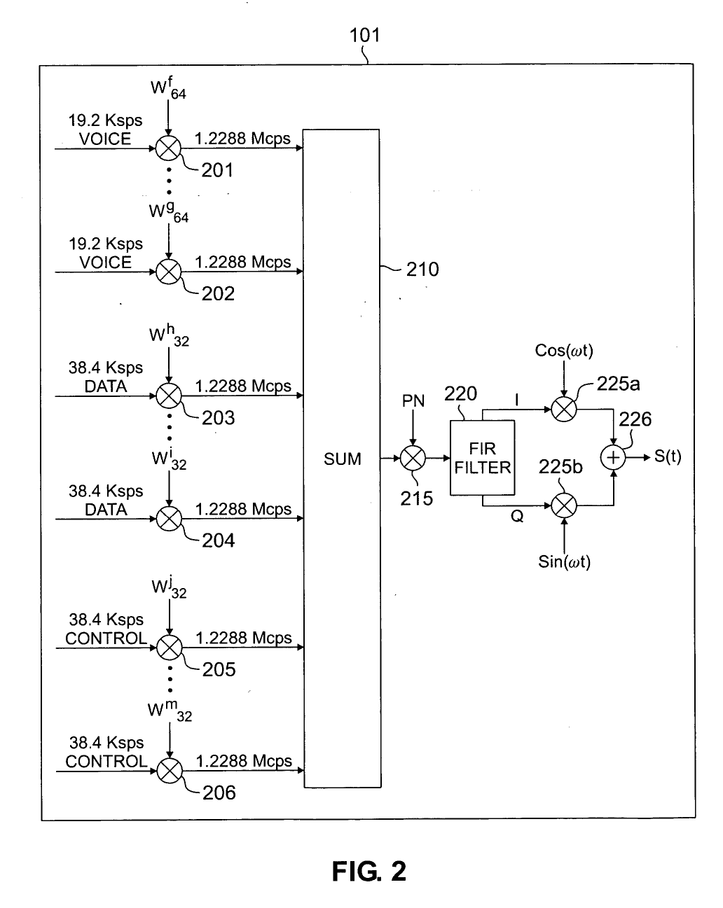

FIG. 2 illustrates selected portions of the transmit path in exemplary base station 101 of wireless network 100 according to an exemplary embodiment of the present invention. Base station 101 comprises a plurality of multipliers, including multipliers 201-206, that multiply each of the data symbols of a plurality of incoming data streams by Walsh code and pseudo-random noise sequences according to the 1xEV-DV standard. The transmit path further comprises summation circuit 210, multiplier 215, finite impulse response (FIR) filter 220, mixers 225a and 225b, and adder 226. The exemplary transmit path in FIG. 1 represents a complex data path of a quadrature phase shift keying (QPSK) radio-frequency (RF) transmitter.

The incoming data streams may be for voice calls, data calls, or control signals. For voice signal, each one of V voice signals received at 19.2 Ksps (kilosymbols per second) is multiplied by one of a number of known 64-chip Walsh code sequences. For example, exemplary multiplier 201 multiplies each symbol in a first 19.2 Ksps voice signal stream by a 64-chip Walsh code, W^{f}. This produces a first 1.2288 Mcps (megachip per second) output. Similarly, exemplary multiplier 202 multiplies each symbol in a second 19.2 Ksps voice signal stream by a 64-chip Walsh code, W^{g}. This produces a second 1.2288 Mcps output.

For data signals, each one of D data signals received at 38.4 Ksps (kilosymbols per second) is multiplied by one of a number of known 32-chip Walsh code sequences. For example, exemplary multiplier 203 multiplies each symbol in a first 38.4 Ksps data signal stream by a 32-bit Walsh code, W^{h}. This produces a third 1.2288 Mcps output. Similarly, exemplary multiplier 204 multiplies each symbol in a second 38.4 Ksps voice signal stream by a 32-bit Walsh code, Wⁱ. This produces a fourth 1.2288 Mcps output.

For control signals, each one of C control signals received at multiples of 9.6 Ksps (kilosymbols per second) is multiplied by one of a number of known multiples of a 32-chip Walsh code sequences depending on the specific channel. For example, exemplary multiplier 205 multiplies each symbol in a first 19.2 Ksps control signal stream by a 64-bit Walsh code, W^{j}. This produces a fifth 1.2288 Mcps output. Similarly, exemplary multiplier 206 multiplies each symbol in a second 38.4 Ksps control signal stream by a 32-bit Walsh code, W^{m}. This produces a sixth 1.2288 Mcps output.

Summation circuit 210 combines all of the 1.2288 Mcps outputs from all of the multipliers. Multiplier 215 then multiples the combined output signal from summation circuit 210 by a complex pseudo-random noise (PN) chip sequence. According to an exemplary embodiment of the present invention, base station 111 transmits one copy of the output of summation circuit 210, but mobile station 111 receives k different copies due to multi-path scattering. FIR filter 220 filters the output of multiplier 215 and outputs an in-phase (I) component signal and a quadrature (Q) component signal.

Mixer 225a performs up-conversion by multiplying the in-phase output of FIR filter 220 by the reference signal cos(ωt). Mixer 225b performs carrier modulation by multiplying the quadrature output of FIR filter 220 by the reference signal sin(ωt). The cos(ωt) and sin(ωt) reference signals are generated by a local oscillator. Adder 226 combines the outputs of mixer 225a and mixer 225b which are then up-converted, if necessary, to generate the RF output signal, S(t), which is then amplified and transmitted to mobile stations in wireless network 100.

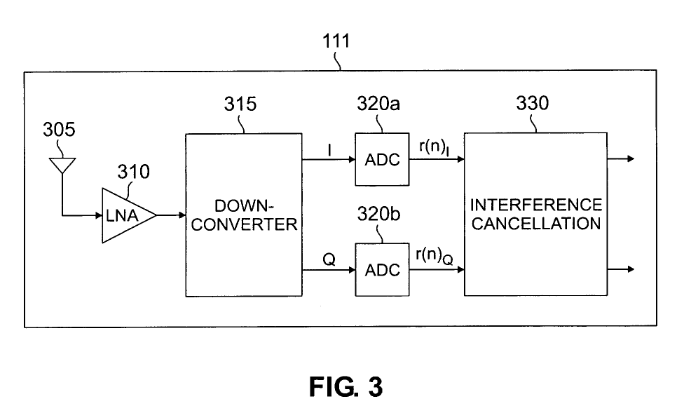

FIG. 3 illustrates selected portions of the receive path of exemplary mobile station 111, which cancels interference according to the principles of the present invention. The received path of mobile station 111 comprises antenna 305, low noise amplifier (LNA) 310, down-converter 315, analog-to-digital converter (ADC) 320a, analog-to-digital converter (ADC) 320b, interference cancellation circuit 330.

Antenna 305 receives the RF signal, S(t), transmitted by base station 101. LNA 310 amplifies the incoming RF signal received by antenna 305 to a suitable level for processing. Down-converter 315 down-converts the amplified RF signal to an intermediate frequency (IF) signal or baseband signal. According to an advantageous embodiment of the present invention, down-converter 315 is a quadrature phase shift keying (QPSK) device that outputs an in-phase (I) signal and a quadrature (Q) signal. ADC 320a converts the in-phase signal from an analog signal to a sequence of digital samples, r(n)_{I}, and ADC 320b converts the quadrature signal from an analog signal to a sequence of digital samples, r(n)_{Q}. Interference cancellation circuit 330 cancels interference from the r(n) signal according to the principles of the present invention.

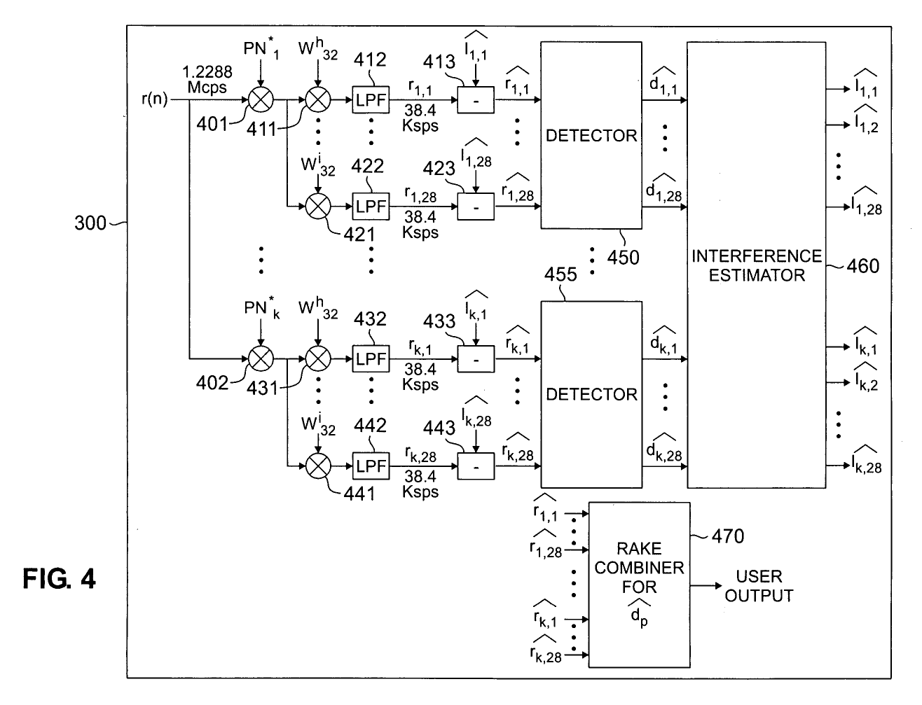

FIG. 4 illustrates in greater detail selected portions of interference cancellation circuits 330 in exemplary mobile station 111 according to an exemplary embodiment of the present invention. Interference cancellation circuit 330 in FIG. 4 is intended to be a generic representation that cancels interference of the packet data channel signal in the sequence of digital samples, r(n).

Interference cancellation circuit 300 comprises a plurality of first stage complex PN demodulators, including exemplary complex PN demodulators 401 and 402, a plurality of Walsh code demodulators in a second stage, including exemplary demodulators 411, 421, 431 and 441, and a plurality of low-pass filters, including exemplary low-pass filters 412, 422, 432, and 442. Interference cancellation circuit 300 further comprises a plurality of detectors, including exemplary detectors 450 and 455, interference estimator 460, and RAKE combiner 470.

The sequence of digital samples, r(n), represents a chip stream arriving at 1.2288 Mcps. The r(n) input signal is applied to k PN demodulators, corresponding to the k multi-path components detected including exemplary PN demodulators 401 and 402. There is one demodulator for each of the k PN offsets received by mobile station 111. Each demodulator multiples the r(n) signal by the pseudo-random noise (PN) sequence to recover the combined Walsh code sequences. For example, if mobile station 111 will cancel 4 same cell multi-path Interference components on the forward channel signal using four (k=4) PN offsets (corresponding to 4 multi-path components), then the r(n) signal in interference cancellation circuit 300 is applied to four input stage demodulators. In such an embodiment, the four input stage demodulators multiply the r(n) input signal by PN₁, PN₂, PN₃, and PN₄, respectively. If, in an alternate embodiment, mobile station 111 will cancel only 2 same cell multi-path Interference components on the forward channel signal using two (k=2) PN offsets (corresponding to only 2 multi-path components), then the r(n) signal in interference cancellation circuit 300 is applied to two input stage demodulators, namely PN demodulators 401 and 402. In such an embodiment, demodulator 401 multiplies the r(n) input signal by PN₁ and demodulator 402 multiplies the r(n) input signal by PN₂.

Each output of an input stage demodulator is then applied to the inputs of W second stage Walsh code demodulator. For each input stage demodulator, there is a second stage demodulator for each of the Walsh codes that are used for the packet data channel, and the desired Walsh code channel in wireless network 100. For example, if base station 101 transmits voice, data and control signals using 28 Walsh codes (i.e., W=28), then the output of each first stage demodulator is input to 28 second stage Walsh code demodulators. Thus, for example, the output of demodulator 401 is applied to 28 demodulators, including exemplary Walsh code demodulators 411 and 421. Similarly, the output of demodulator 402 is applied to 28 demodulators, including exemplary Walsh code demodulators 431 and 441. The Walsh code demodulators multiply the outputs of the input stage demodulators by the 32-bit Walsh codes used in wireless network 100 to produce W copies of raw user signals, r.

The raw user signal, r, output from each Walsh code demodulator is applied to a low-pass filter (LPF) to produce a filtered raw user signal, r, at 38.4 kilosymbols per second (ksps). For example, LPF 412 filters the output of demodulator 411 to produce the filtered raw user signal, r_{1,1}. If 28 Walsh codes are used (i.e., W=28), LPF 422 filters the output of demodulator 421 to produce filtered raw user signal, r_{1,28}. This is repeated for all W Walsh codes and for all K PN offsets. Thus, if two PN offsets and 28 Walsh codes are used, there are 56 low-pass filters that produce 56 filtered raw user signals, r_{1,1} through r_{1,28} and r_{2,1} through r_{2,28}, at 38.4 ksps.

Each output of a low-pass filter is applied to one input of a subtractor, such as exemplary subtractors 413, 423, 433 and 443. The other input of each subtractor is an estimated interference signal, Î. Each subtractor subtracts the estimated interference value from the raw user signal received from a low-pass filter to produce an estimated user signal, \hat{r}. For example, subtractor 413 receives the raw user signal r_{1,1} and subtracts the estimated interference signal Î_{1,1} to produce the estimated user signal, \hat{r}_{1,1}.

For each PN offset, there is a detector that receives all of the estimated user signals corresponding to that PN offset. For example, detector 450 receives all of the estimated user signals, \hat{r}_{l,1} through \hat{r}_{l,28}, associated with PN₁ and the set of W Walsh codes. Similarly, detector 455 receives all of the estimated user signals, \hat{r}_{k,1} through \hat{r}_{k,28}, associated with PNₖ and the set of W Walsh codes. Each detector produces a detected user output for each estimated user signal for each path and each of the W Walsh code channels. Thus, for example, detector 450 produces the detected user signals, \hat{d}_{1,1} through \hat{d}_{1,28}, associated with PN₁, corresponding to each of the W Walsh code channels.

According to an advantageous embodiment of the present invention, the detectors (e.g., detectors 450 and 455) are threshold detectors that compare the outputs of the subtractors to predetermined threshold values to determine whether or not a signal is present for each Walsh code channel. If an estimated user signal does not exceed the predetermined threshold, the detector outputs a zero value for the detected user signal in the corresponding Walsh code channel. For example, if the value of the estimated user signal, \hat{r}_{1,1}, at the output of subtractor 413 does not exceed the predetermined threshold, detector 450 outputs a zero for the detected user signal, \hat{d}_{1,1}.

Interference estimator 460 receives all of the detected interference signals associates with all of the K PN offsets and W Walsh codes and produces the estimated interference signals, Î, used by the subtractors. Additionally, RAKE combiners 470 receives all of the estimated user signals (e.g., r_{1,1} through r_{1,28} and r_{2,1} through r_{2,28}) to generate a user output signal in mobile station 111.

According to an advantageous embodiment of the present invention, interference estimator 460 compares the interference in each detected user signal to a predetermined threshold value to determine whether or not a strong interference signal is present in each detected user signal. If the interference in a detected user signal does not exceed the predetermined threshold, interference estimator 460 outputs a zero value for the corresponding estimated interference signals, Î. For example, if the interference in the detected user signal, \hat{d}_{1,1} is weak and does not exceed the predetermined threshold, interference estimator 460 outputs a zero value for the estimated interference signal, Î_{1,1}. According to an advantageous embodiment of the present invention, the strongest interference signal will correspond to the Walsh code that is used for the Packet Data Channel. Thus, the estimated interference signal that is applied to each subtractor will largely comprise interference caused by the Packet Data Channel.

The present invention provides a unique algorithm for canceling interference and improving signal quality in a single antenna mobile station. Although the algorithm of the present invention may be used for voice channels and data channels, voice channels may gain the most from the present invention, since voice channels are typically at a very low power compared to the data channels. Successive interference cancellation techniques in the prior art first determine the strongest channel, cancel the strongest channel, and then repeat this process for all channels.

However, in 1xEV-DV and 1xEV-DO, there is only one dominant channel, namely the Packet Data Channel (PDCH), which is known to be the strongest channel. The present invention takes advantage of this knowledge and cancels the known PDCH. A consequence of knowing that the PDCH needs to be canceled is that mobile station 111 needs to know which Walsh codes the PDCH uses. This information is typically broadcast by BS 101 on either the Packet Data Control Channel (PDCCH) or the broadcast channel. MS 111 does not need to extract all of the information from these channels. However, MS 111 does extract the Walsh code map from these channels. Thus, the algorithm of the present invention is particularly suited to 1xEV-DV mobile stations, which already have the ability to obtain Walsh codes maps from the Packet Data Control Channel (PDCCH) or the broadcast channel. MS 111 can estimate the multi-path components very accurately since all forward channels come from the same source (e.g., BS 101).

The algorithm of the present invention may be explained as follows. The receive path of MS 111 operates on the received RF signal by applying the appropriate complex PN code. Since the present invention is primarily concerned with canceling data interference, it is assumed that the present invention will be working with length N=32 Walsh codes.

The algorithm of the present invention works with Walsh codes of other lengths, as long as the mobile station knows which Walsh codes are being used by the Packet Data Channel. In a 1xEV-DV system, this information may be distributed in two ways. First, the Walsh code map may be broadcast on a broadcast channel periodically. Second, the exact Walsh codes used for each time slot may be transmitted on the Packet Data Control Channel. The exemplary embodiment uses the Walsh code map that is available via the broadcast channel and estimates the specific Walsh codes used every timeslot of 1.25 milliseconds, corresponding to the smallest possible interval that the Walsh codes may change.

Equation 1 below expresses the complex transmitted CDMA signal at time n:

$$s ( n - k ) = {\sum }_{p = 1}^{P} {d}_{kp} {W}_{p} ( n - k ) C ( n - k ) \qquad [ Eqn . 1 ]$$

where k represents the multi-path component and as such k=0 at the transmitter, dₖₚ are the complex data symbols modulated on the p'th Walsh code, Wₚ(n) is the length N=32 Walsh code of the p'th code channel, and C(n) is the corresponding complex PN code. The structure of the transmitter is shown above in FIG. 2. Equation 2 below expresses the signal received at mobile station 111:

$$r ( n ) = {\sum }_{k = 0}^{K - 1} {\sum }_{p = 1}^{P} {a}_{k} {d}_{kp} {W}_{p} ( n - k ) C ( n - k ) + u ( n ) + {I}_{adj} , \qquad [ Eqn . 2 ]$$

where aₖ is the physical channel corresponding to the k'th multipath, u(n) is the thermal white noise and I_{adj} is the adjacent channel interference.

The algorithm of the present invention is not concerned with canceling adjacent channel interference, since mobile station (MS) 111 does not have sufficient information to do this. However, if MS 111 is in soft-handoff, MS 111 may cancel interference from the adjacent cell since MS 111 would be connected to the corresponding base station and would be able to get the needed information to cancel the interference.

The detected l'th finger corresponding to the (p′)'th data symbol is given by Equation 3 below, as follows:

$$\begin{matrix}{r}_{{lp}^{′}} = {\sum }_{n = 0}^{N} {C}^{*} ( n - l ) {W}_{{p}^{′}} ( n - l ) r ( n ) \\ = {Na}_{l} {d}_{{p}^{′} l} + {\sum }_{n = 0}^{N} {\sum }_{k \neq l}^{K - 1} {\sum }_{p = 1}^{P} {a}_{k} {d}_{p k} {C}^{*} ( n - l ) \\ {W}_{{p}^{′}} ( n - l ) {W}_{p} ( n - k ) C ( n - k ) + {u}^{′}\end{matrix} \qquad [ Eqn . 3 ]$$

where u′ is the demodulated thermal noise plus adjacent channel interference. Then a normal RAKE combine, such as RAKE combiner 470, given a channel estimate (âₖ), would reconstruct the symbol according to Equation 4 below:

$${\hat{d}}_{{p}^{′}} = {\sum }_{l = 0}^{K - 1} {\hat{a}}_{l}^{*} {r}_{{lp}^{′}} \qquad [ Eqn . 4 ]$$

The algorithm of the present invention is particularly suited to an RF environment that is dominated by same cell interference. In such an environment, the dominant interference term in Equation 3 above is given by Equation 5 below:

$$\begin{matrix}{I}_{l , {p}^{′}} = {\sum }_{n = 0}^{N} {\sum }_{k \neq l}^{K - 1} {\sum }_{p = 1}^{P} {a}_{k} {d}_{p k} {C}^{*} ( n - l ) \\ {W}_{{p}^{′}} ( n - l ) {W}_{p} ( n - k ) C ( n - k ) .\end{matrix} \qquad [ Eqn . 5 ]$$

The algorithm of the present invention reduces the dominant interference, thereby increasing capacity. Ideally, there is perfect synchronization and estimates of all the aₖ values to thereby enable the following iterative approach.

Step 1—Mobile station 111 estimates the value of \hat{d}ₚ, using the conventional RAKE technique (without doing any interference cancellation) given in Equation 6 below:

$${\hat{d}}_{{p}^{′}} = {\sum }_{l = 0}^{K - 1} {\hat{a}}_{l}^{*} {r}_{{lp}^{′}} \qquad [ Eqn . 6 ]$$

Step 2—Mobile station 111 estimate which Walsh codes are being used for a particular time slot. This could be done using simple threshold detection at the output of the Walsh demodulator (e.g., demodulators 411, 421, etc.). Since all the Walsh channels are transmitted using the same power for data channels, and since this is consistent over all the RAKE fingers, it is a straightforward process to detect which Walsh demodulator outputs produce high power signals and which do not. This places a constraint on the system to only cancel strong interferers, namely the Packet Data Channel. Therefore, if the signal-to-noise ratio (SNR) of the interferer signal is too low, the interferer signal would not be cancelled.

Step 3—Mobile station 111 estimate interference to the (p′)'th channel on the l'th finger using Equation 7 below:

$$\begin{matrix}{\hat{I}}_{l , {p}^{′}} = {\sum }_{n = 0}^{N} {\sum }_{k \neq l}^{K - 1} {\sum }_{p = 1}^{P} {\hat{a}}_{k} {\hat{d}}_{p k} {C}^{*} ( n - l ) \\ {W}_{{p}^{′}} ( n - l ) {W}_{p} ( n - k ) C ( n - k )\end{matrix} \qquad [ Eqn . 7 ]$$

In FIG. 4, the complex PN code on the l'th multipath is represented as PNₖ=C(n−k), as is represented in the equations here. Note that if the interference is below a certain threshold it defaults to zero, thereby not canceling weak signals.

Step 4—The subtractors in FIG. 4 estimate the RAKE fingers after interference cancellation using Equation 8 below:
\hat{r}_{lp′}=r_{lp′}−Î_{lp′} [Eqn. 8]

Step 5—Detectors 450, 455 re-estimate the symbols \hat{d}_{p′} using Equation 9 below:

$${\hat{d}}_{{p}^{′}} = {\sum }_{l = 0}^{K - 1} {\hat{a}}_{l}^{*} {\hat{r}}_{{lp}^{′}} \qquad [ Eqn . 9 ]$$

The algorithm of the present invention is not interested in decoding the symbols to bits. Thus, the present invention is not concerned with the meaning of the symbols, just in the values of the symbols so that cancellation may be performed.

Step 6—Mobile station 111 continues to iterate from Step 2 above until convergence occurs, using any conventional convergence test, such as mean square error, where the error is defined as the difference between the symbol estimates between iterations.

The algorithm of the present invention is represented schematically in FIG. 4. Voice channels are just a special case of data channels. Thus, voice and control channels are considered to be equivalent to data at half the data rate of 19.2 kbps. The actual voice bits are then calculated by Equation 10 below as:
\hat{d}ᵥ=\hat{d}_{p′}(1)+(−1)^{y}_{p′}(2) [Eqn. 10]
where the value of y depends on which length=64 Walsh code is used for the voice channel (e.g., W₆₄=[W^{p′}₃₂(−1)^{y}W^{p′}₃₂])

There are many simplifications of this method that can be implemented in a practical receiver. For example, mobile station 111 may instead estimate the data symbols and the channel together in a single step:
\overline{aₖdₚ}=\hat{r}ₖₚ [Eqn. 11]
thereby reducing the number of computations.

The complexity of the algorithm shown in FIG. 4 may be further reduced by demodulating the different Walsh code channels for the packet data sequentially and storing the results of the demodulated symbols \hat{d}ₚ, and interference Îₗₚ, corresponding to each of the 28 Walsh-32 codes, as an example.

Although the present invention has been described with an exemplary embodiment, various changes and modifications may be suggested to one skilled in the art. It is intended that the present invention encompass such changes and modifications as fall within the scope of the appended claims.

What is claimed is:

1. For use in a 1xEV-DV wireless network, a mobile station capable of canceling interference caused by a dominant interferer signal comprising:
a radio frequency (RF) down-converter for receiving an RF signal and outputting a down-converted signal, r(n);
a first pseudo-random noise (PN) demodulator capable of multiplying said down-converted r(n) signal by a first PN code sequence to produce a first demodulated output signal;
a first group of W Walsh code demodulators, each of said W Walsh code demodulators capable of multiplying said first demodulated output signal by a selected Walsh code used in said 1xEV-DV wireless network to produce a raw user signal, said first group of W Walsh codes demodulates producing W raw user signals;
a first group of W subtractors, each of said W subtractors capable of subtracting a selected estimated interference signal from a corresponding one of said W raw user signals to produce an estimated user signal, said first group of W subtractors thereby producing W estimated user signals; and
a first detector capable of receiving said W estimated user signals and determining which of said W estimated user signals exceeds a first threshold value.

2. The mobile station as set forth in claim 1, wherein said first detector outputs a detected user signal for each of said W estimated user signals, said first detector thereby producing W detected user signals.

3. The mobile station as set forth in claim 2, wherein said first detector outputs a detected user signal equal to zero for each of said W estimated user signals that does not exceed said first threshold value.

4. The mobile station as set forth in claim 2, further comprising an interference estimator capable of receiving said W detected user signals from said first detector and comparing an interference signal in each of said W detected user signals to a second threshold value.

5. The mobile station as set forth in claim 4, wherein said interference estimator outputs an estimated interference signal for each of said W detected user signals, said interference estimator thereby producing a first group of W estimated interference signals.

6. The mobile station as set forth in claim 5, wherein said interference estimator outputs an estimated interference signal equal to zero for each of said W detected user signals in which said interference signal does not exceed said second threshold value.

7. The mobile station as set forth in claim 5, wherein each of said W estimated interference signals is applied as an input to a corresponding one of said W subtractors.

8. The mobile station as set forth in claim 7, further comprising:
a second pseudo-random noise (PN) demodulator capable of multiplying said down-converted r(n) signal by a second PN code sequence offset from said first PN code sequence to produce a second demodulated output signal;
a second group of W Walsh code demodulators, each of said second group of W Walsh code demodulators capable of multiplying said second demodulated output signal by a selected Walsh code to produce a raw user signal, said second group of W Walsh code demodulates producing W raw user signals;
a second group of W subtractors, each of said second group of W subtractors capable of subtracting a selected estimated interference signal from a corresponding one of said W raw user signals produced by said second group of W Walsh code demodulators to produce an estimated user signal, said second group of W subtractors thereby producing W estimated user signals; and
a second detector capable of receiving said W estimated user signals produced by said second group of W subtractors and determining which of said W estimated user signals exceeds a first threshold value.

9. The mobile station as set forth in claim 8, wherein said second detector outputs a detected user signal for each of said W estimated user signals produced by said second group of W subtractors, said second detector thereby producing W detected user signals.

10. The mobile station as set forth in claim 9, wherein said second detector outputs a detected user signal equal to zero for each of said W estimated user signals produced by said second group of W subtractors that does not exceed said first threshold value.

11. The mobile station as set forth in claim 9, wherein said interference estimator receives said W detected user signals from said second detector and compares an interference signal in each of said W detected user signals from said second detector to said second threshold value.

12. The mobile station as set forth in claim 11, wherein said interference estimator outputs an estimated interference signal for each of said W detected user signals from said second detector, said interference estimator thereby producing a second group of W estimated interference signals.

13. The mobile station as set forth in claim 12, wherein said interference estimator outputs an estimated interference signal equal to zero for each of said W detected user signals from said second detector in which said interference signal does not exceed said second threshold value.

14. The mobile station as set forth in claim 12, wherein each of said second group of W estimated interference signals is applied as an input to a corresponding one of said second group of W subtractors.

15. For use in a mobile station capable of communicating with a 1xEV-DV wireless network, a method of canceling interference caused by a dominant interferer signal comprising the steps of:
receiving an RF signal and generating therefrom a down-converted signal, r(n);
multiplying the down-converted r(n) signal by a first PN code sequence to produce a first demodulated output signal;
multiplying the first demodulated output signal by each Walsh code used in the 1xEV-DV wireless network to thereby produce W raw user signals;
in each of W subtractors, subtracting a selected estimated interference signal from each of a corresponding one of the W raw user signals to thereby produce W estimated user signals; and
determining which of the W estimated user signals exceeds a first threshold value.

16. The method as set forth in claim 15, further comprising the step of generating a detected user signal for each of the W estimated user signals to thereby produce W detected user signals.

17. The method as set forth in claim 16, further comprising the step of generating a detected user signal equal to zero for each of the W estimated user signals that does not exceed the first threshold value.

18. The method as set forth in claim 16, further comprising the step of comparing an interference signal in each of the W detected user signals to a second threshold value.

19. The method as set forth in claim 18, further comprising the step of generating an estimated interference signal for each of the W detected user signals to thereby produce a first group of W estimated interference signals.

20. The method as set forth in claim 19, further comprising the step of generating an estimated interference signal equal to zero for each of the W detected user signals in which the interference signal does not exceed the second threshold value.

21. The method as set forth in claim 19, further comprising the step of applying each of the W estimated interference signals as an input to a corresponding one of the W subtractors.
